(19) United States
(12) Patent Application Publication
(10) Pub. No.: US 2023/0084066 A1
(43) Pub. Date: Mar. 16, 2023

(54) SYSTEM AND METHOD FOR DISPERSION COMPENSATION IN FIBERED OPTICAL COMMUNICATION PATHS

(71) Applicant: HUAWEI TECHNOLOGIES CO., LTD., Shenzhen (CN)

(72) Inventor: Zhiping JIANG, Kanata (CA)

(21) Appl. No.: 17/474,360

(22) Filed: Sep. 14, 2021

(51) Int. Cl. H04B 10/2525; H04J 14/02; H04B 10/2519

(52) U.S. Cl. CPC H04B 10/25253; H04J 14/0212; H04B 10/2519

(57) ABSTRACT

A system for dispersion compensation for a fibered communication path, the system being configured for connection with a node of the fibered communication path. The system includes a controller; a wavelength selective switch (WSS) communicatively coupled to the controller, the WSS being configured for operatively coupling to at least one fiber of the fibered communication path; and dispersion compensation modules (DCM) optically connected to the WSS. Each DCM is configured to provide a particular compensation for dispersion in light received therein, the controller being configured to determine, for each wavelength received from the at least one fiber, an accumulated dispersion, and cause, for each wavelength received from the at least one fiber, the WSS to send each wavelength to a particular one of the plurality of DCMs having the particular compensation corresponding to the accumulated dispersion of each wavelength.

### TECHNICAL FIELD

The present disclosure generally relates to the field of optical communication networks and, in particular, to systems and methods for compensating dispersion in optical communication paths in optical networks.

### BACKGROUND

Typical implementation of optical networks involve use of broadband wavelength light. For propagation over any particular optical path, chromatic dispersion in the broadband signal accumulates.

In intensity modulation/direct detection (IM/DD) fibered communication systems, chromatic dispersion is often compensated by one or more inline Dispersion Compensation Fibers (DCF) having negative dispersion, or one or more Dispersion Compensation Modules (DCM). As is illustrated in FIG. 1, many compensation modules 15 (i.e. DCFs and/or DCMs), paired with amplifiers 18, are often arranged in series along a particular fiber path to manage dispersion.

In coherent communication systems, receivers in the communication system can recover the full electrical signal. Chromatic dispersion accumulated in the signal can thus be removed in the digital or electronic domain; no inline compensation modules are needed, as is illustrated in FIG. 2. While there is lower loss and cost over an arrangement including DCMs, power consumption in such a receiver chip is greatly increased.

To this end, there remains an interest in being able to compensate dispersion over different wavelengths in fibered optical communication paths.

### SUMMARY

By way of introduction, an object of the present disclosure (that is, one general purpose of this disclosure) is to provide a system and method for compensating dispersion in a fibered communication path.

According to at least some aspects of the invention, there is provided a dispersion compensation system for providing wavelength-specific dispersion compensation. The system includes at least one wavelength selective switch (WSS), communicatively connected to a controller, in order to separate out wavelengths and direct each wavelength to a specific dispersion compensation module (DCM). Each wavelength is directed to the DCM configured with the dispersion compensation most closely matching the accumulated dispersion of that particular wavelength.

According to one aspect, there is provided a system for dispersion compensation for a fibered communication path, the system being configured for connection with a node of the fibered communication path. The system includes a controller; a wavelength selective switch (WSS) communicatively coupled to the controller, the WSS being configured for operatively coupling to at least one fiber of the fibered communication path; and a plurality of dispersion compensation modules (DCM) optically connected to the WSS, each DCM of the plurality of DCMs being configured to provide a particular compensation for dispersion in light received therein, the controller being configured to: determine, for each wavelength received from the at least one fiber, an accumulated dispersion, and cause, for each wavelength received from the at least one fiber, the WSS to send each wavelength to a particular one of the plurality of DCMs having the particular compensation corresponding to the accumulated dispersion of each wavelength.

In some embodiments, the plurality of dispersion compensation modules includes a plurality of chirped fiber Bragg gratings (FBG).

In some embodiments, the plurality of fiber Bragg gratings are configured in a reflective arrangement.

In some embodiments, each one of the plurality of dispersion compensation modules includes a fiber Bragg grating (FBG); a circulator optically connected to the fiber Bragg grating; and an amplifier operatively connected to the circulator.

In some embodiments, each one of the plurality of dispersion compensation modules includes a dispersion compensation fiber.

In some embodiments, each one of the plurality of dispersion compensation modules further includes a circulator optically connected to the dispersion compensation fiber; and an amplifier operatively connected to the circulator.

In some embodiments, the system further includes: a circulator optically connected between the at least one fiber and the WSS; and the WSS is configured to send each wavelength to its corresponding one of the plurality of DCMs; the WSS is arranged to receive a compensated signal from each one of the plurality of DCMs; and the WSS is configured to return the compensated signal of each wavelength to the circulator; and the circulator is arranged to direct the compensated signals to at least one output fiber.

In some embodiments, the WSS is a first WSS; and further including a second WSS optically connected between the plurality of DCMs and at least one output fiber, the second WSS being arranged to receive and combine compensated signals from the plurality of DCMS.

In some embodiments, the system further includes a coupler optically connected between the plurality of DCMs and at least one output fiber, the coupler being arranged to receive and combine compensated signals from the plurality of DCMS.

According to another aspect, there is provided a system for dispersion compensation for a fibered communication path, the system being configured for connection with a node of the fibered communication path. The system includes a plurality of compensation units, each unit including a controller; a wavelength selective switch (WSS) communicatively coupled to the controller, the WSS being configured for receiving a broadband optical signal; a dispersion compensation module (DCM) optically connected to the WSS; and a coupler optically connected to the WSS and the DCM.

In some embodiments, each DCM of the plurality of compensation units has a different magnitude of compensation configured to compensate a particular predetermined dispersion in light received therein, each controller being configured to control the WSS to separate light received therein into a wavelength to be compensated and remaining light to transmit to a corresponding coupler.

In some embodiments, each DCM of the plurality of compensation units is configured to compensate a same magnitude of dispersion.

In some embodiments, the plurality of compensation units are connected together in series.

According to another aspect, there is provided a method for managing dispersion in a fibered optical communication path, at least one fiber of the fibered optical path being optically connected to a system for dispersion compensation. The method includes determining, by a controller of the system for dispersion compensation, an accumulated dispersion for a given wavelength of light propagating through the at least one fiber; and directing, by a wavelength selective switch (WSS) communicatively coupled to the controller and optically connected to the at least one fiber, light of the given wavelength to one module of a plurality of dispersion compensation modules (DCM) optically connected to the WSS, the one module of the plurality of DCMs being selected for having a dispersion compensation corresponding to the accumulated dispersion for the given wavelength.

### BRIEF DESCRIPTION OF THE DRAWINGS

The features and advantages of the present disclosure will become apparent from the following detailed description, taken in combination with the appended drawings, in which:

FIG. 1 depicts a conceptual diagram of an optical network with dispersion compensation according to the prior art;

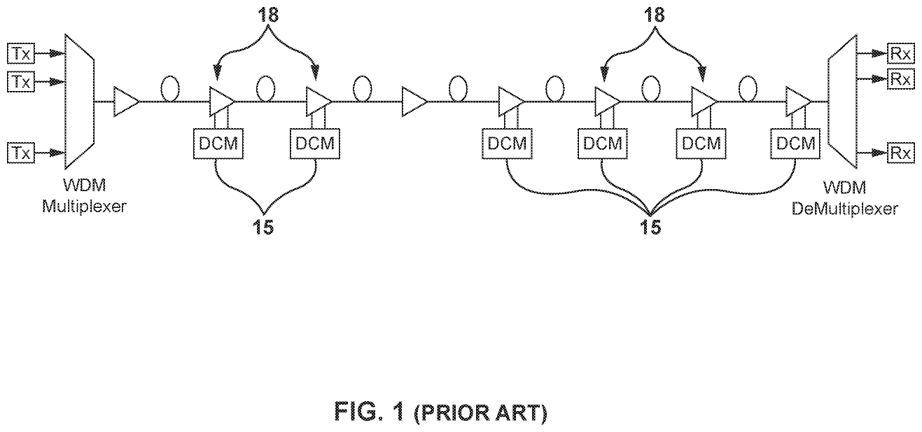

FIG. 2 depicts a conceptual diagram of another optical network with dispersion compensation according to the prior art;

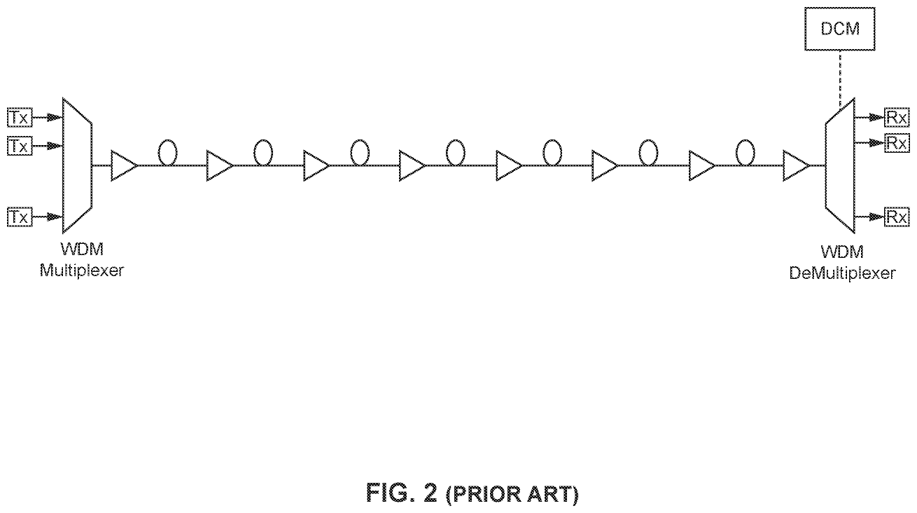

FIG. 3 depicts a conceptual diagram of an optical network according to the present technology;

FIG. 4 schematically depicts an embodiment of a dispersion compensation system of the optical network of FIG. 3;

FIG. 5A schematically depicts a first embodiment is a dispersion compensation module of the dispersion compensation system of FIG. 4;

FIG. 5B schematically depicts a second embodiment of the dispersion compensation module of the dispersion compensation system of FIG. 4;

FIG. 5C schematically depicts a third embodiment of the dispersion compensation module of the dispersion compensation system of FIG. 4;

FIG. 5D schematically depicts a fourth embodiment of the dispersion compensation module of the dispersion compensation system of FIG. 4;

FIG. 6 schematically depicts another embodiment of a dispersion compensation system of the optical network of FIG. 3;

FIG. 7A schematically depicts a first embodiment is a dispersion compensation module of the dispersion compensation system of FIG. 6;

FIG. 7B schematically depicts a second embodiment of the dispersion compensation module of the dispersion compensation system of FIG. 6;

FIG. 8 schematically depicts another embodiment of a dispersion compensation system of the optical network of FIG. 3;

FIG. 9 schematically depicts yet another embodiment of a dispersion compensation system of the optical network of FIG. 3;

FIG. 10 schematically depicts yet another embodiment of a dispersion compensation system of the optical network of FIG. 3; and

FIG. 11 depicts a flowchart illustrating an embodiment of a method for operating the dispersion compensation system of FIG. 4.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims.

### DETAILED DESCRIPTION

Various representative embodiments of the described technology will be described more fully hereinafter with reference to the accompanying drawings, in which representative embodiments are shown. The present technology concept may, however, be embodied in many different forms and should not be construed as limited to the representative embodiments set forth herein. Rather, these representative embodiments are provided so that the disclosure will be thorough and complete, and will fully convey the scope of the present technology to those skilled in the art. In the drawings, the sizes and relative sizes of layers and regions may be exaggerated for clarity. Like numerals refer to like elements throughout.

It will be understood that, although the terms first, second, third, etc. may be used herein to describe various elements, these elements should not be limited by these terms. These terms are used to distinguish one element from another. Thus, a first element discussed below could be termed a second element without departing from the teachings of the present technology. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular representative embodiments and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “controller”, “processor” or “processing unit”, may be provided through the use of dedicated hardware as well as hardware capable of executing software in association with appropriate software and according to the methods described herein. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules or units which are implied to be software, may be represented herein as any combination of flowchart elements or other elements indicating performance of process steps and/or textual description. Such modules may be executed by hardware that is expressly or implicitly shown, the hardware being adapted to (made to, designed to, or configured to) execute the modules. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present disclosure.

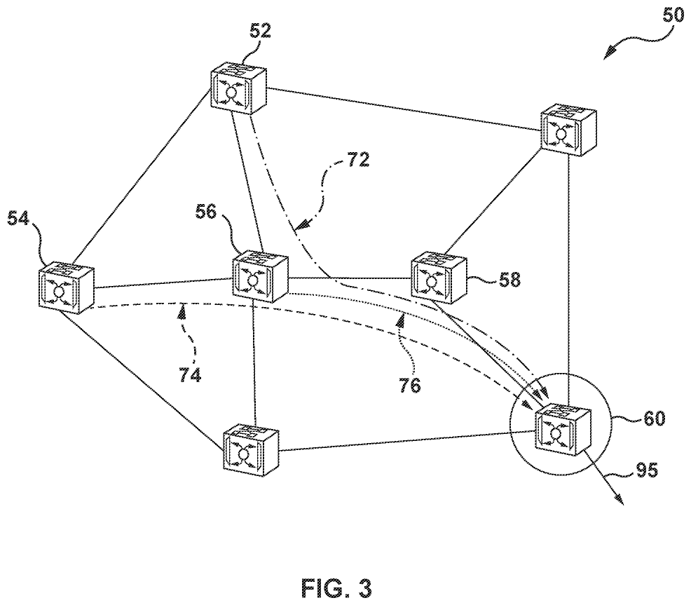

With reference to FIG. 3, there is illustrated a conceptual diagram of an optical network 50 that may be addressed by the systems and methods presented herein. As shown, the optical network 50 typically includes a plurality of optical nodes 52, 54, 56, 58, 60 that may include optical multiplexing sections (OMSs) comprising optical add-drop multiplexers, such as, for example, a reconfigurable optical add-drop multiplexers (ROADMs) each containing at least one wavelength selective switch (WSS). Each node may be configured to add, remove, and/or reroute a wavelength. Each OMS based node may further comprise multiple optical transport sections (OTSs), where at each OTS the wavelength remains same. Further, each node 52, 54, 56, 58, 60 in the optical network 50 may incorporate multiple optical amplifiers, e.g., erbium-doped fiber amplifiers (EDFAs), for amplifying the optical signals. The optical network 50 may further employ one or more optical network elements and modules (which may include either or both of active and passive elements/modules), such as, for example, optical filters, WSSs, arrayed waveguide gratings, optical transmitters, optical receivers, processors and other suitable components. However, for purposes of simplicity and tractability, these elements have been omitted from the Figures.

By way of example, an implementation of the optical network 50 generally includes a plurality of fibers, embodying different paths, extending from node to node or location to location. While only a handful of nodes and fibers are illustrated, it should be understood that the optical network 50 generally includes many more nodes and fibers (in various more or less complex configurations) which form the network 50.

Signals propagating from any given node to another, for example a signal 72 being transmitted from the node 52 to the node 60, experience chromatic dispersion due to the relative velocity of different wavelengths of light in a broadband signal. At any given node, however, it is noted that a dropped or detected signal could be a combination of signals that have taken different paths through the network 50, such as the signals 72, 74, 76. The signals 72, 74, 76 may contain different wavelengths depending on the applications addressed. In such a case, the dispersion accumulated by the combined signal of signals 72, 74, 76 could vary beyond simply chromatic dispersion along a given path.

Hence, a key point of interest would be to provide a solution for addressing different magnitudes of dispersion for any given wavelength of a signal, in a manner that optimizes equipment cost and power consumption. According to the present disclosure, compensation of light arriving at the node 60 can be performed by a dispersion compensation system 100 (described in more detail below). The treated signal can then either be accessed (dropped) or amplified and propagated onward via an output fiber 95.

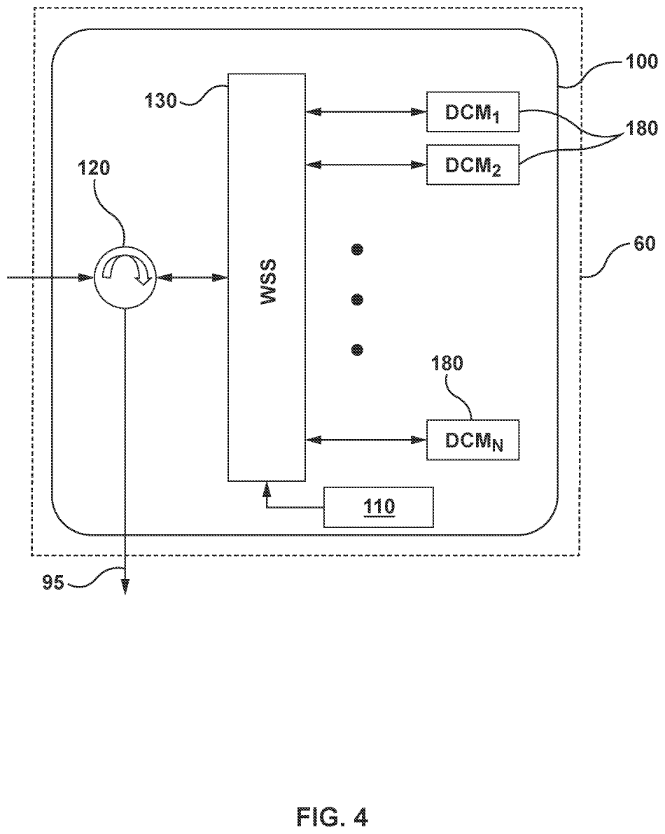

With reference to FIG. 4, the dispersion compensation system 100 for a fibered communication path is schematically illustrated. In the illustrated non-limiting example, the system 100 is depicted disposed in the node 60, although it is contemplated that the system 100 or additional systems 100 could be included in any number of nodes in a given optical network 50. Depending on the particular embodiment, the compensation system 100 could be arranged to perform compensation upstream from receivers in the node 60. It is also contemplated that the system 100 could be disposed in a transmitter side of the node 60.

The dispersion compensation system 100 includes a controller 110 for operating one or more components of the system 100 and for perform methods of dispersion compensation (described in additional detail below). While illustrated as being a stand-alone controller 110 of the system 100, in at least some embodiments the controller 110 could be implemented by one or more computational devices of the node 60 or of the optical network 50.

The system 100 includes a circulator 120 arranged to receive optical signals arriving at the system 100. The circulator 120 is further configured to transmit received signals onto further components of the system 100 (as is described further below), receive treated signals from these components of the system 100, and then pass on the treated signals out to the output fiber 95.

The system 100 further includes a wavelength selective switch (WSS) 130, optically and operatively connected to the circulator 120. The particular implementation of the WSS 130 could vary depending on the particular embodiment. In at least some embodiments, the WSS 130 could be implemented as a flex grid wavelength selection switch but is not limited thereto. The WSS 130 is configured to receive the optical signal from the circulator 120, the optical signal including a plurality of wavelengths having a variety of accumulated dispersions. The WSS 130 is communicatively connected to the controller 110, which controls the WSS 130 to cause it to divide the signal by wavelength as is described in more detail below.

The system 100 further includes a plurality of dispersion compensation modules (DCM) 180 optically connected to the WSS 130. Each DCM 180 is configured to compensate a particular magnitude of accumulated dispersion. In the embodiment illustrated in FIG. 4, each DCM 180 is in a reflection configuration, where signals received from the WSS 130 are treated and then reflected back to the WSS 130.

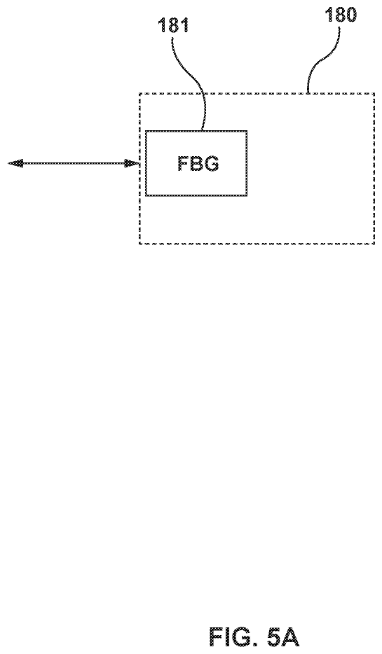

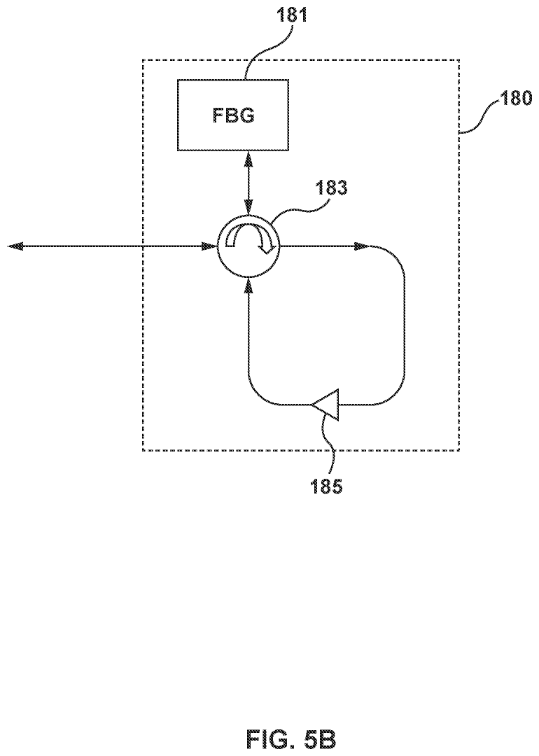

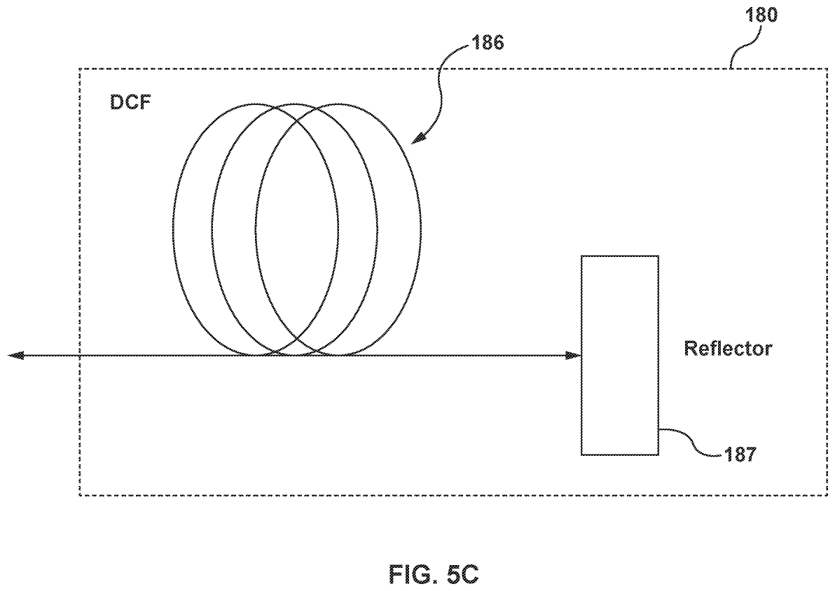

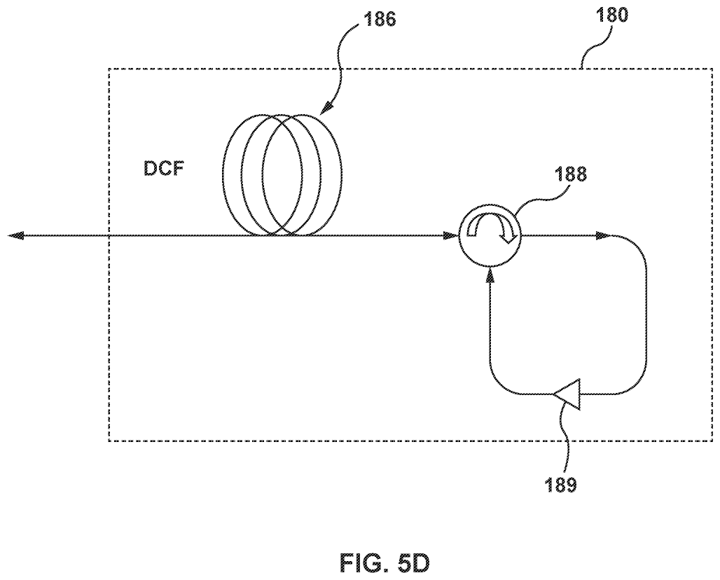

Depending on the particular system 100 and the particular optical network 50, it is contemplated that the plurality of DCMs 180 could be implemented in a number of ways. For example, as is illustrated in FIG. 5A, one or more of the DCMs 180 could be implemented using a chirped fiber Bragg grating (FBG) 181 in a reflective configuration. With reference to FIG. 5B, one of more of the DCMs 180 could be implemented using the reflective FBG 181, arranged in a loop with a circulator 183 and an amplifier 185, to provide signal amplification. In some embodiments, one or more of the DCMs 180 could be implemented using a dispersion compensation fiber (DCF) 186 paired with a reflector 187, as is illustrated in FIG. 5C. It is also contemplated that one or more of the DCMs 180 could be implemented using the DCF 186 of FIG. 5C, paired with a circulator 188 and an amplifier 189, as is illustrated in FIG. 5D. It is further contemplated that any one particular embodiment of the system 100 could include more than one of the example DCM implementations illustrated herein. It is also contemplated that additional implementations of dispersion compensation modules, not mentioned herein, could be utilized.

With the basic components in place, operation of the dispersion compensation system 100 will now be described with continued reference to FIG. 4. The optical signal, such as a combination of the signals 72, 74, 76 discussed above, arrives at the system 100. The circulator 120 then transmits the signal to the WSS 130. The controller 110 then controls the WSS 130 to separate different wavelengths of the signal. The WSS 130 sends each wavelength to a particular one of the DCMs 180. Specifically, the controller 110 determines the accumulated dispersion for each wavelength and controls the WSS 130 to direct each wavelength to the DCM 180 configured to compensate a magnitude of dispersion closest to the determined accumulated dispersion for that particular wavelength. In some embodiments, it is contemplated that the signal could be separated into small wavelength bands by the WSS 130. Depending on the embodiment, accumulated dispersion and corresponding compensation values may be determined based on the link topology of the particular network 50. For example, the accumulated dispersion of a particular wavelength of the received signal could be determined by the controller 110 based on at least the wavelength, fiber type, and fiber length of traversed spans of the given wavelength.

After passing through the DCMs 180, arranged in reflection configuration, the WSS 130 receives and recombines the different wavelengths of the signal, now at least partially dispersion compensated. The recombined, at least partially compensated signal then propagates back to the circulator 120. The circulator 120 then directs the compensated signal to the output fiber 95. It is noted that for one or more wavelengths, the accumulated dispersion (prior to treatment by the system 100) may not be perfectly compensated by the DCM 180 configured with the closest magnitude of compensation, as the different modules 180 have discrete amounts of compensation. This leaves a residual dispersion of the difference between the accumulated dispersion and the discrete compensation magnitude. Residual dispersion is then digitally corrected in the node 60 or a final receiver per standard procedure. As the residual dispersion following treatment is small relative to the previously accumulated dispersion, digital compensation consumes much less energy than would have been the case without treatment by the system 100.

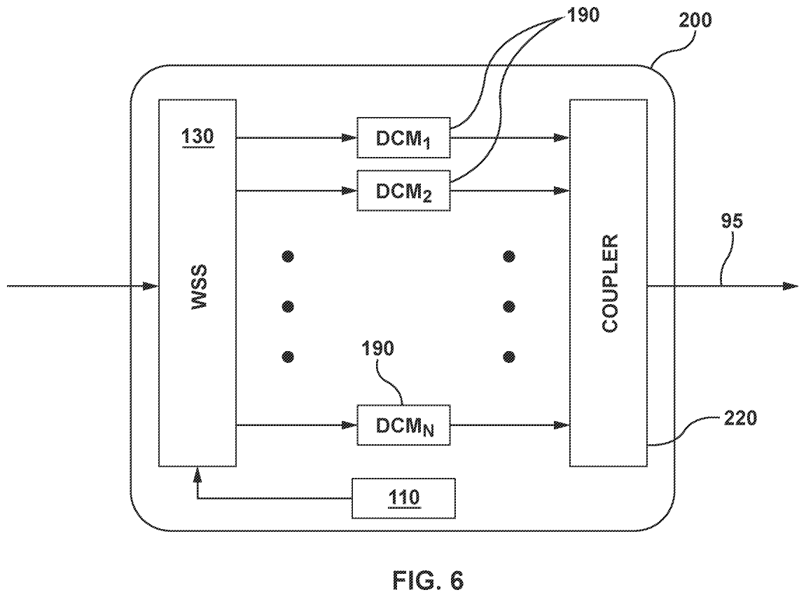

With reference to FIG. 6, there is illustrated another non-limiting embodiment of a dispersion compensation system 200 for a fibered communication path. Elements of the dispersion compensation system 200 that are similar to those of the dispersion compensation system 100 retain the same reference numeral and will generally not be described again.

The dispersion compensation system 200 is arranged in a transmission configuration, but otherwise operates similarly to the dispersion compensation system 100. The WSS 130 receives the wavelength mixed signal from the optical network 50. In the system 200, the WSS 130 is operatively connected to a plurality of transmission-configured dispersion compensation modules (DCM) 190. Each DCM 190 is configured to compensate a particular magnitude of dispersion, similarly to the DCMs 180.

The system 200 further includes a coupler 220 optically connected to the DCMs 190, for recombining the different wavelengths of the signal following treatment by the DCMs 190. An output of the coupler 220 is optically connected to the output fiber 95 to which the recombined signal is provided during use.

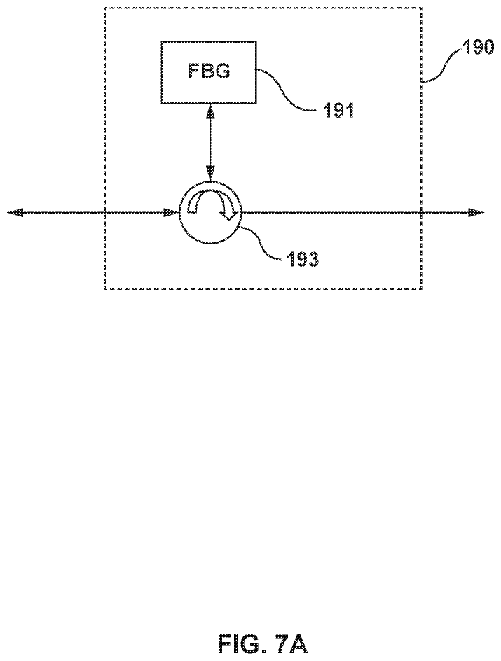

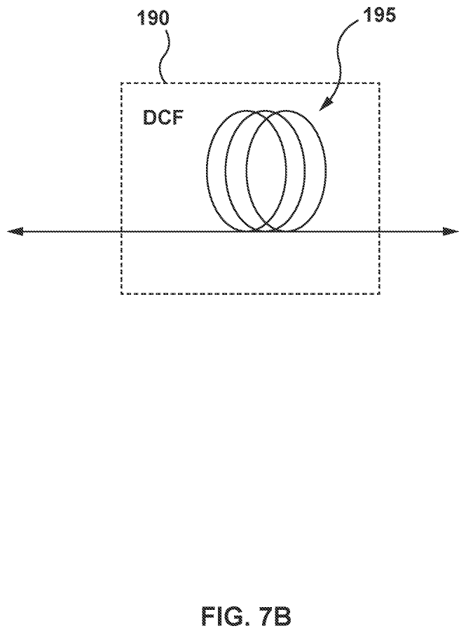

Depending on the particular system 200 and the particular optical network 50, it is contemplated that the plurality of DCMs 190 could be implemented in a number of ways. For example, as is illustrated in FIG. 7A, one or more of the DCMs 190 could be implemented using a chirped fiber Bragg grating (FBG) 191 in a reflective configuration, arranged in a loop with a circulator 193. The circulator 193 receives a portion of the signal from the WSS 130, provides the signal to the FBG 191, receives the treated signal portion from the FBG 191 (as the FBG 191 works in reflection), and then outputs the treated signal portion to be collected by the coupler 220. In some embodiments, one or more of the DCMs 190 could be implemented using a dispersion compensation fiber (DCF) 195, as is illustrated in FIG. 7B.

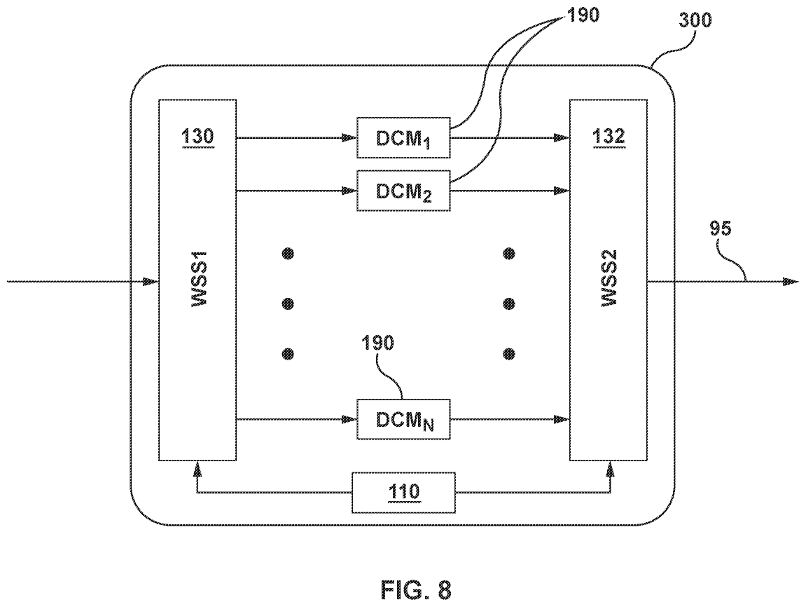

Another implementation of a dispersion compensation system 300 is illustrated in FIG. 8. Elements of the dispersion compensation system 300 that are similar to those of the dispersion compensation systems 100, 200 retain the same reference numeral and will generally not be described again.

In the dispersion compensation system 300, the DCMs 190 are again arranged in transmission, similarly to the system 200. To recombine the compensated signals, the system 300 includes a second wavelength selective switch (WSS) 132 optically connected to the DCMs 190. The second WSS 132 is also operatively connected to the controller 110 such that the controller 110 can provide instructions to both of the WSSs 130, 132. The second WSS 132, during use, recombines the treated signals from the DCMs 190. In some embodiments, the arrangement of the system 200, using the coupler 220 could be chosen for lower costs, while the arrangement of the system 300 could be chosen for the relatively lower loss using the second WSS 132.

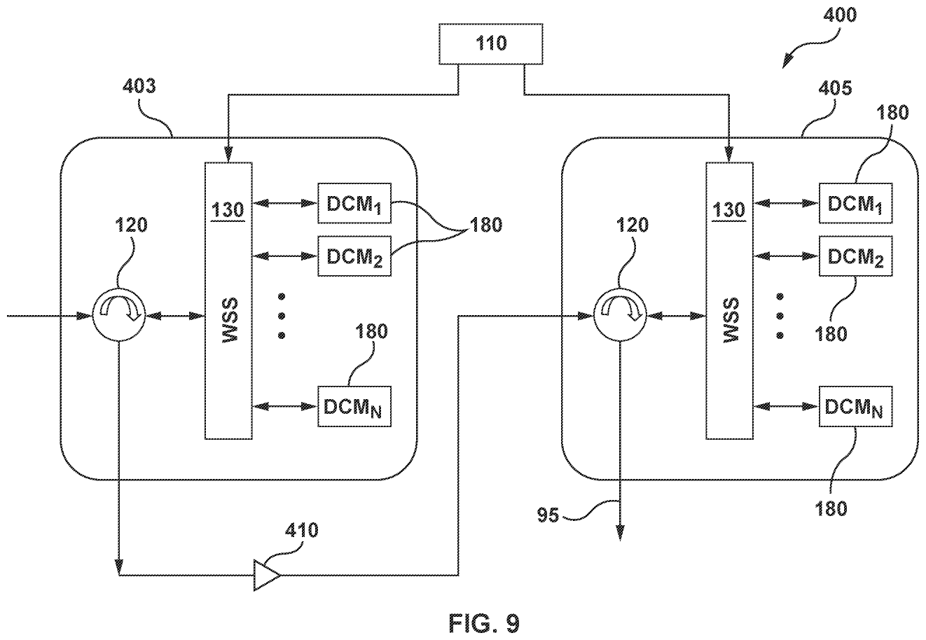

Yet another implementation of a dispersion compensation system 400 is illustrated in FIG. 9. Elements of the dispersion compensation system 400 that are similar to those of the dispersion compensation system 100 retain the same reference numeral and will generally not be described again.

The dispersion compensation system 400 is formed from a first unit 403 and a second unit 405. Each unit 403, 405 includes the general structure of the system 100. It is also contemplated that the system 400 could implement another embodiment of the system, such as the structure of the system 200, in one or both of the units 403, 405.

The system 400, as illustrated, further includes an amplifier 410 operatively connected between an output of the first unit 403 and an input of the second unit 405, in order to amplify the partially treated signal. It is contemplated that the amplifier 410 could be omitted in at least some embodiments. Depending on the embodiment, the particular compensation magnitudes of each DCM 180 could vary. In another non-limiting example, the set of DCMs 180 of the first unit 403 could have greater magnitudes of compensation than the set of DCMs 180 in the second unit 405. As one non-limiting example, the first unit 403 and the second unit 405 could have matching sets of DCMs 180.

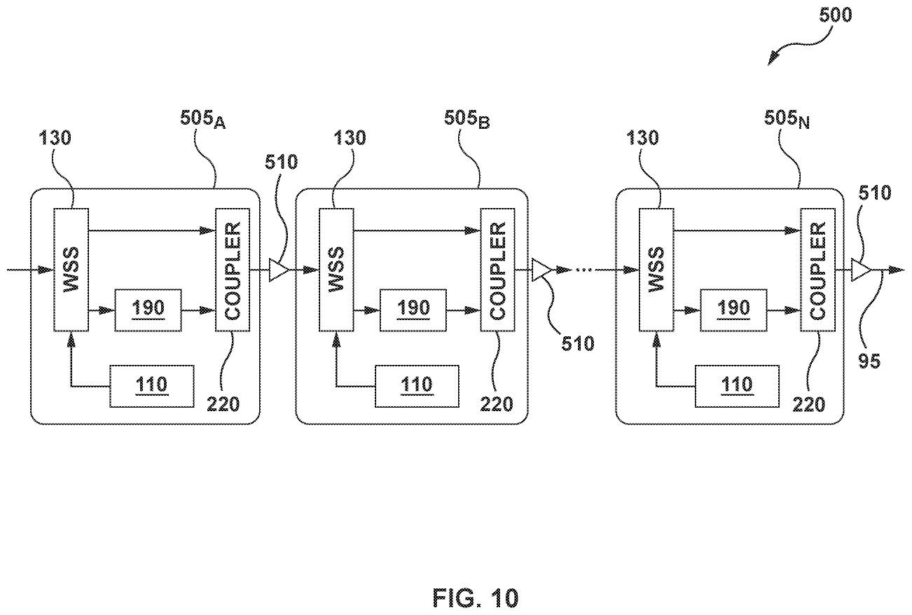

Yet another implementation of a dispersion compensation system 500 is illustrated in FIG. 10. Elements of the dispersion compensation system 500 that are similar to those of the dispersion compensation systems 100, 200 retain the same reference numeral and will generally not be described again.

The system 500 is formed from a series of dispersion compensation units 505A, 505B, . . . 505_{N}, the units 505_{N} having a cascading arrangement with each one connected to the adjacent in series. In the illustrated example, each unit 505ₓ connected to the next unit 505ₓ via an amplifier 510. It is contemplated that one or more of the amplifiers 510 could be omitted in some embodiments. Each one of the units 505_{N} is arranged in transmission, with a structure similar to that of the above described system 200. Each unit 505_{N}, in contrast, only includes one transmission-configured DCM 190 connected between the WSS 130 and the coupler 220. By cascading a series of units 505_{N}, dispersion compensation is applied to one or more wavelengths in each unit 505_{N} such that the total compensation applied after completing processing by the system 500 compensates for the accumulated dispersion of each wavelength. By cascading the units 505_{N}, the total number of different DCMs 190 required to compensate a large range of dispersion accumulations may be reduced. While each unit 505_{N} is illustrated with a separate controller 110, it is contemplated that one controller could manage more than one or all of the units 505_{N}.

In at least some embodiments, the DCM 190 of each of the units 505_{N} could be configured to compensate for a same amount of dispersion. In some other embodiments, the compensation magnitudes could vary between different units 505_{N}. It is also contemplated that one or more of the units 505_{N} could be replaced with a unit formed from one of the above described multi-DCM compensation systems 100, 200, 300, 400.

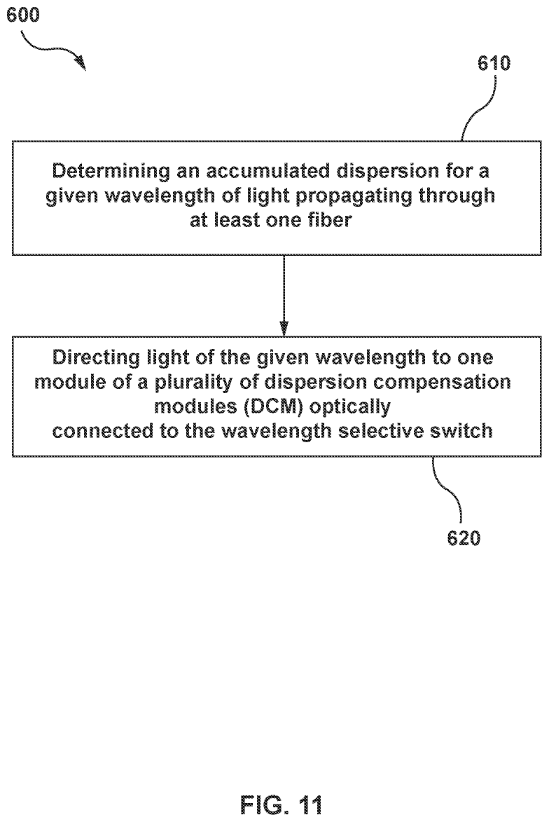

In FIG. 11, a method 600 for managing dispersion in a fibered communication path is illustrated. The method 600 is described below as performed by the controller 110 in the dispersion compensation system 100, but in at least some implementations it is contemplated that the method 600 could be performed using another embodiment, such as one or more of the systems 200, 300, 400, 500.

The method 600 begins, at step 610, with determining, by the controller 110, an accumulated dispersion for one or more wavelengths of light propagating through the fibered communication path. As is mentioned above, determining the accumulated dispersion could depend on the particular wavelength as well as the particular path traveled by the light through the network 50.

The method 600 continues, at step 620, with directing, by the wavelength selective switch 130, light of the one or more wavelengths to one or more corresponding DCMs 180. As is described above, the controller 110 causes the WSS 130 to send each wavelength of the signal to the DCM 180 which has the closest magnitude of compensation to the dispersion accumulated by that particular wavelength. As is noted above, due to the modular nature of the DCMs 180, the accumulated dispersion for any given wavelength portion of the signal may not be exactly compensated by the system 100. In such cases, residual dispersion may generally be compensated digitally.

It will also be understood that, although the embodiments presented herein have been described with reference to specific features and structures, it is clear that various modifications and combinations may be made without departing from such disclosures. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

1. A system for dispersion compensation for a fibered communication path, the system being configured for connection with a node of the fibered communication path, the system comprising:
a controller;
a wavelength selective switch (WSS) communicatively coupled to the controller, the WSS being configured for operatively coupling to at least one fiber of the fibered communication path; and
a plurality of dispersion compensation modules (DCM) optically connected to the WSS, each DCM of the plurality of DCMs being configured to provide a particular compensation for dispersion in light received therein,
the controller being configured to:
determine, for each wavelength received from the at least one fiber, an accumulated dispersion, and
cause, for each wavelength received from the at least one fiber, the WSS to send each wavelength to a particular one of the plurality of DCMs having the particular compensation corresponding to the accumulated dispersion of each wavelength.

2. The system of claim 1, wherein the plurality of dispersion compensation modules includes a plurality of chirped fiber Bragg gratings (FBG).

3. The system of claim 2, wherein the plurality of fiber Bragg gratings are configured in a reflective arrangement.

4. The system of claim 1, wherein each one of the plurality of dispersion compensation modules comprises:
a fiber Bragg grating (FBG);
a circulator optically connected to the fiber Bragg grating; and
an amplifier operatively connected to the circulator.

5. The system of claim 1, wherein each one of the plurality of dispersion compensation modules comprises a dispersion compensation fiber.

6. The system of claim 5, wherein each one of the plurality of dispersion compensation modules further comprises:
a circulator optically connected to the dispersion compensation fiber; and
an amplifier operatively connected to the circulator.

7. The system of claim 1, further comprising:
a circulator optically connected between the at least one fiber and the WSS; and
wherein:
the WSS is configured to send each wavelength to its corresponding one of the plurality of DCMs;
the WSS is arranged to receive a compensated signal from each one of the plurality of DCMs; and
the WSS is configured to return the compensated signal of each wavelength to the circulator; and
the circulator is arranged to direct the compensated signals to at least one output fiber.

8. The system of claim 1, wherein:
the WSS is a first WSS; and
further comprising a second WSS optically connected between the plurality of DCMs and at least one output fiber,
the second WSS being arranged to receive and combine compensated signals from the plurality of DCMS.

9. The system of claim 1, further comprising a coupler optically connected between the plurality of DCMs and at least one output fiber, the coupler being arranged to receive and combine compensated signals from the plurality of DCMS.

10. A system for dispersion compensation for a fibered communication path, the system being configured for connection with a node of the fibered communication path, the system comprising:
a plurality of compensation units, each unit comprising:
a controller;
a wavelength selective switch (WSS) communicatively coupled to the controller, the WSS being configured for receiving a broadband optical signal;
a dispersion compensation module (DCM) optically connected to the WSS; and
a coupler optically connected to the WSS and the DCM.

11. The system of claim 10, wherein:
each DCM of the plurality of compensation units has a different magnitude of compensation configured to compensate a particular predetermined dispersion in light received therein,
each controller being configured to control the WSS to separate light received therein into a wavelength to be compensated and remaining light to transmit to a corresponding coupler.

12. The system of claim 10, wherein each DCM of the plurality of compensation units is configured to compensate a same magnitude of dispersion.

13. The system of claim 10, wherein the plurality of compensation units are connected together in series.

14. A method for managing dispersion in a fibered optical communication path, at least one fiber of the fibered optical path being optically connected to a system for dispersion compensation, the method comprising:
determining, by a controller of the system for dispersion compensation, an accumulated dispersion for a given wavelength of light propagating through the at least one fiber; and
directing, by a wavelength selective switch (WSS) communicatively coupled to the controller and optically connected to the at least one fiber, light of the given wavelength to one module of a plurality of dispersion compensation modules (DCM) optically connected to the WSS, the one module of the plurality of DCMs being selected for having a dispersion compensation corresponding to the accumulated dispersion for the given wavelength.
